(19) United States
(12) Patent Application Publication
(10) Pub. No.: US 2010/0009162 A1
(43) Pub. Date: Jan. 14, 2010

(54) SEALING INSERT FOR CONTAINER CLOSURES

(75) Inventor: Peter Rothweiler, Freden an der Leine (DE)

Correspondence Address: SALTER & MICHAELSON;THE HERITAGE BUILDING, 321 SOUTH MAIN STREET, PROVIDENCE, RI, 029037128, US

(73) Assignee: ALFELDER KUNSTSTOFFWERKE HERM. MEYER GMBH, Alfeld/Leine (DE)

(21) Appl. No.: 12/305,991

(22) PCT Filed: Jun. 20, 2007
(86) PCT No.: PCT/EP07/56143

§ 371 Date: Aug. 19, 2009

(30) Foreign Application Priority Data
Jun. 28, 2006 (DE) 10 2006 030 116.1
Oct. 9, 2006 (DE) 10 2006 048 009.0

(51) Int. Cl. B65D 53/04; B32B 7/12; B65D 53/00

(52) U.S. Cl. 428/317.1; 428/411.1

(57) ABSTRACT

The invention relates to a sealing insert for container closures, comprising a support layer, a transparent lamination film and an adhesive layer joining the lamination film to support layer. The adhesive layer has a different light/dark value and/or a different colour than the support layer. The adhesive layer, in particular, is coloured.

The invention relates to a sealing insert for container closures with a support layer, with a transparent lamination film, and with an adhesive layer connecting the lamination film to the support layer.

Sealing inserts for container closures are often made of foamed polyethylene or foamed polypropylene. These sealing inserts are disc-shaped and are generally round, and thus form a cylindrical disc overall. As such they are already a commercially available product.

This product is generally then only made of a homogeneous material. However, this sealing disc can also be used as support for a more complex product. The disc of foamed polyethylene or foamed polypropylene then forms a support layer. In addition to the support layer, which has a heat insulating, insulating and sealing function and because of its foam-like consistency is able to compensate certain production tolerances, the sealing inserts are often provided with a further material property. Thus, it is desirable that certain barrier properties are additionally provided, e.g. in the form of oxygen or water vapour barriers. Specific mechanical properties such as sliding properties or a further mechanical sealing function are also desirable. In order to achieve this, the support layers are provided with a corresponding lamination film.

This lamination film is also referred to as a barrier film. It is adhered to the surface of the foamed material of the support layer by means of an adhesive, e.g. a polyolefin. This adhesive is generally hot in order to assist the bonding process of the lamination film to the support layer. Therefore, the adhesion process can be referred to in some sense as a welding process.

Therefore, the main component of the sealing insert is a support layer, usually a foam-extruded white layer. The laminated film is transparent. Polyethylene films, for example, are used for lamination here. The foam-extruded support layer and the lamination film are adhered to one another and then the desired sealing discs are punched out of the resulting complete web.

In the case of a white support layer each individual sealing disc appears white from both sides, since the lamination film is clear and transparent. Other colorations of the lamination film would also be readily possible in principle, and this is also desirable in practice. For example, the users of sealing discs would be interested in the sealing disc being matched to the colour of the packaged product, for instance by also providing orange juice with container closures that appear orange to the observer on their inside.

In a completely different context, it has already been proposed in the relatively old publications FR 1 558 341 and U.S. Pat. No. 2,620,939 to provide one side of sealing discs with a different colour from the other side of these sealing discs. The sealing discs could then be oriented during insertion on the basis of this colour.

However, these older publications are not concerned with sealing discs with lamination film on one side, as described above, and likewise do not give any indications to details.

In practice, however, the demand for coloured laminated sealing inserts is frustrated because, while colouring of the transparent polyethylene film is possible, it would be very expensive. The production plants for such polyethylene films would have to be refitted for this purpose in order to incorporate colour pigments into the production, and they would have to be refitted again to then return to the production of clear transparent polyethylene films required for all other applications. While the number of sealing inserts required for container closures is very high, the surface required in the individual case is very small, and therefore production of coloured transparent polyethylene films for this one purpose of use of a quite specific customer is not profitable or is uneconomically expensive for this customer.

A coloration of the support layer in the foam extrusion process while retaining clear, transparent lamination films would also be physically possible. However, there would also be problem here that the foam extrusion plant would have to be respectively refitted in a costly and time-consuming manner in order to add a specific tint to the foamed material. A very thorough cleaning of the foam extrusion plants as well as a refit back again would then likewise be necessary.

Therefore, it has not been possible hitherto to fulfil this wish expressed from user circles, or if so only in rare special cases that justify the high refit costs.

Accordingly, it is an object of the invention to propose a more economical possibility of enabling sealing inserts for container closures to be supplied to users that generate the impression of being coloured or at least not pure white to the observer.

This object is achieved with a sealing insert for container closures with a support layer, with a transparent lamination film, and with an adhesive layer connecting the lamination film to the support layer, wherein the adhesive layer has a different light/dark value and/or a different colour from the support layer.

The invention makes use of the knowledge that such a sealing insert for container closures does not only consist of the two essential components of support layer, on the one hand, and lamination film, on the other, which both the manufacturers of sealing inserts and the users are conversant with as individual components.

However, there is additionally the largely unnoticed adhesive layer, with which these two essential components are actually joined to one another. This adhesive layer may indeed be negligible in quantity in relation to the other components of the sealing insert and is moreover also located between the other two components and thus in a concealed space that is not intrusive with respect to optical effects.

However, the fact here is that the lamination film is clear and transparent, so that an observer can see through it to the support layer. However, the adhesive layer is in fact located between the lamination film and the support layer, so that a preferred coloured adhesive layer according to the invention gives the observer the impression that the entire sealing insert is provided with a colour.

Moreover, the adhesive layer has the advantage that it is only inserted at the end when the sealing insert comprising the two main components is produced and joined together, and is available for a variable and targeted inclusion of colour pigments. It is not produced as a foam extrusion element, nor does a lamination film web have to be provided beforehand.

Namely, the adhesive layer is preferably an extruded hot adhesive medium, in particular an extruded polyolefin with an added dye in this case.

There is a broad selection of such dyes and it is also possible to change the colouring of this adhesive medium relatively quickly in order to produce differently coloured sealing inserts.

The sealing inserts thus formed would be coloured, e.g. orange, on one side for the observer and white on the other side, since the observer sees the non-laminated surface of the support layer there and not the surface provided with an adhesive layer.

If desired, the second adhesive layer may also be coloured accordingly.

It is also conceivable to provide both adhesive layers with different pigments on the different sides in the supplied components for the adhesive layers and thus provide a sealing insert that gives an impression of being coloured differently on the two sides.

It is naturally also possible to provide sealing discs with a laminated film on both sides, which is respectively joined to the support layer by means of an adhesive layer. Then both sides of the sealing disc or sealing insert can be provided with different colours by differently colouring the two adhesive layers. This can make sense, for example, in order to distinguish between two sorts of a product to be accommodated in the container by inserting the sealing inserts differently into container closures or to provide the end user with a different optical impression in each case. Two different tints can now appear beside the distinction of white (caused by the support layer) and coloured (caused by the adhesive layer) possible with a lamination film and an adhesive layer.

However, there is also a practical reason why sealing discs are frequently and expediently provided with a lamination film on both sides, although the user only requires a lamination on one side in the finished sealing insert. The sealing inserts must, however, be fed to container closures in feeder machines, into which they must be inserted. So that the sealing inserts can be fed to the feeder machines as economically as possible, the sealing inserts are packed loose in cartons. They are then filled into feed hoppers or similar devices from these cartons.

To enable the sealing inserts packed loose in the cartons in this manner to also be processed in the machines and ensure that the lamination is also provided on the correct side usually adjacent to the filling material in every case after insertion into the closure, the lamination of the support layer occurs on both sides. The sealing inserts are then symmetrical, so that it is immaterial during further processing which side of a sealing insert then lies adjacent to a filling material to be packed, for example.

Otherwise, a costly orientation of the sealing inserts would have to be conducted at the manufacturers by packing them in tubes. The time-consuming filling of the feeder machines and hoppers with tubes containing only a few hundred sealing inserts at the closure manufacturers can then also be saved.

The feeder machines can thus remove and insert the sealing discs using the processes in the prior art, since the sealing insert can perform the same functions from both sides.

So long as the lamination films incur costs, which lie in the order of the material for the support layers or so long as the material costs are still largely negligible in relation to the production and processing costs of the sealing inserts, it is possible without any problem to simply provide both sides of a sealing insert with lamination films solely to achieve symmetry, although a lamination on one side of the sealing insert would be fully sufficient for the practical case of application.

It should be considered in this case that the feeder machines for the sealing inserts work very quickly and the feed rate is extremely high. Therefore it would not be feasible for the processing operation to provide time for sorting and handling sealing inserts when feeding them into container closures.

However, there are also application cases, in which the lamination films are extremely costly. This applies for instance when very high-grade barrier films are to be used, which are desirable as oxygen-impermeable layers in specific application cases.

In such cases a double-sided lamination of the support layers is no longer feasible, since it also results in double the area of the extremely costly lamination films being used.

Assistance can be provided here by an embodiment of the invention. Namely, an embodiment is used here, in which viewed from the side covered by the lamination film, the sealing insert has a different light/dark value and/or a different colour from the side of the support layer not covered by the lamination film, namely because the single adhesion layer in this case is coloured in particular.

The problem can be solved with this seemingly very simple measure. While all previous attempts to conduct such sorting instance by testing the slightly different sliding properties of both sides of the sealing insert with or without lamination film have failed because the differences are too small, an intense optical colour difference or difference in the light/dark value with different grey tones can certainly be detected reliably and without problem. There are already optoelectronic devices that are used to orient partially coated discs and distinguish a metal coated side from an uncoated side.

However, while it is possible to see how to distinguish between the two sides of a disc in the case of metal-coated discs, this could certainly not be envisaged in the case of the sealing inserts provided with transparent lamination films, since there was not in fact any light/dark difference between the two sides.

However, now there is a coloured adhesive layer located between this support layer and the lamination film. If one now looks at the non-laminated side, then one still looks in unchanged manner at the white foamed material. However, if one looks at the transparent lamination film from the laminated side and therefore looks through this film, then there now lies a coloured adhesive layer optically in front of the white foamed material layer located behind it.

Depending on requirement, this adhesive layer can be provided with a very intense colour, e.g. an intense red or blue, or also a grey tint that differs as far as possible from white.

The sealing insert therefore has a distinctly different optical effect from the two sides, although nothing has changed from the tactile point of view nor for the substances coming into contact with the sealing insert, since all the changes occur inside the sealing insert.

It is preferred if the adhesive layer is extruded as hot adhesive medium and is inserted between the support layer and the lamination film. In this case, it is particularly preferred if the adhesive layer is formed by an extruded polyolefin with an added dye.

Tests have already shown that appropriate dye can be added to this form of the adhesive layer in a particularly expedient manner, and also only very small amounts of the dye are needed to achieve a distinction between the two sides of the sealing disc that can be detected by the optoelectronic scanners. The adhesion effect can also be adjusted in a particularly reliable manner and is not impaired in any way by the addition of the dye. Alternatively, it is also possible that this coloured adhesion medium or this adhesive layer is an adhesive film sheet. Namely, it then becomes possible to have a web of the support layer material and a web of the lamination film material run one on top of the other from two supply levels and insert the adhesive medium in the form of a polyolefin film web between these. This liquefies easily during or shortly after this operation and therefore adheres the two externally located layers.

The sealing inserts are then punched out and packed loose in cartons. Any checks can already be conducted at this time for testing, since the two sides of the sealing inserts generate a very different optical impression as a result of the coloured polyolefin film web or the coloured adhesive layer.

The practically optional colouring capacity of the adhesive layer also allows taking into account desires of the customers and/or properties of the filling material to be packed, i.e. a red adhesive medium to be used, for example, in the case of sealing inserts for a red liquid (red wine, red fruit juices). These respective sealing inserts are readily visible to some degree depending on the form of use for the end user.

The manufacturer then packs the sealing discs from the carton into a so-called sorter or feeder for example a hopper feeder, from which they are then fed to the feeder machine.

It is very important for the user that nothing is changed physically by the invention except for the different coloration. The surface structures from both sides are precisely as they would be in the case of a conventional non-coloured sealing insert, so that none of the handling mechanisms, feeder machines etc. have to be converted and they can all handle the coloured sealing inserts in precisely the same way as conventional ones from a previous batch.

This also means that the properties required of the lamination film such as food integrity or also admissible properties are not changed, nor are the properties required of the support layer on the other side.

Hence, it is possible without problem to use conventional, non-coloured sealing discs mixed or alternately with the sealing discs according to the invention that generate a coloured impression for the observer. Therefore, the manufacturer of a product is not obliged to firstly use up a batch of conventional sealing discs, then undertake conversions, and only then be able to use the new sealing discs. Instead, he can introduce the novel sealing discs into his production line without problem. Likewise, he does not hold back any residual amounts of previous products that can be used up fully.

Similarly, practically none of the checking and testing measures based on physical properties of the sealing discs, for example, have to be changed. The thickness or the relative density or the total weight of a sealing disc does not change, nor do the coefficients of friction and similar properties. Only the optical properties are changed.

As a result of the changed optical properties, for example, two sealing inserts of different types, laminated with different films, for example, and to be used for very special purposes, can be made distinguishable from one another. Hitherto this was a problem when such sealing discs look completely identical to one another, but can only be used for one purpose in each case. Provision can now be made here from the outset by a specific coloration desired by the customer. These sealing inserts can then be clearly distinguished between by the naked eye.

There are also possibilities of making the two sides of a sealing insert distinguishable from one another by different colorations on the two sides of a support layer. This applies, for example, if different, otherwise clear and transparent lamination films are used on the two sides.

As mentioned, to produce the sealing inserts a multilayered film web is firstly produced. This film web consists of the support layer and adhesive layers that are coloured or non-coloured on one or both sides and then the lamination films.

This complete film web is also an independently marketable product, since it is occasionally desired for packaging reasons or other economic reasons to firstly produce the sealing inserts on site shortly before production of the packaging or before packaging the finished products from the film webs. This is achieved because it is possible to punch the sealing inserts out of these film webs by machine and then use them directly for further processing.

Therefore, to produce these sealing inserts such film webs can also be produced at another site and a considerable time before punching out the sealing inserts to then be supplied as finished web goods in particular in large rolls to the production works for punching. The object of the invention is also achieved with such a film web, in that it can namely provide users with sealing inserts for container closures that generate a coloured impression for the observer.

Two exemplary embodiments of the invention shall be described in more detail below on the basis of the drawing:

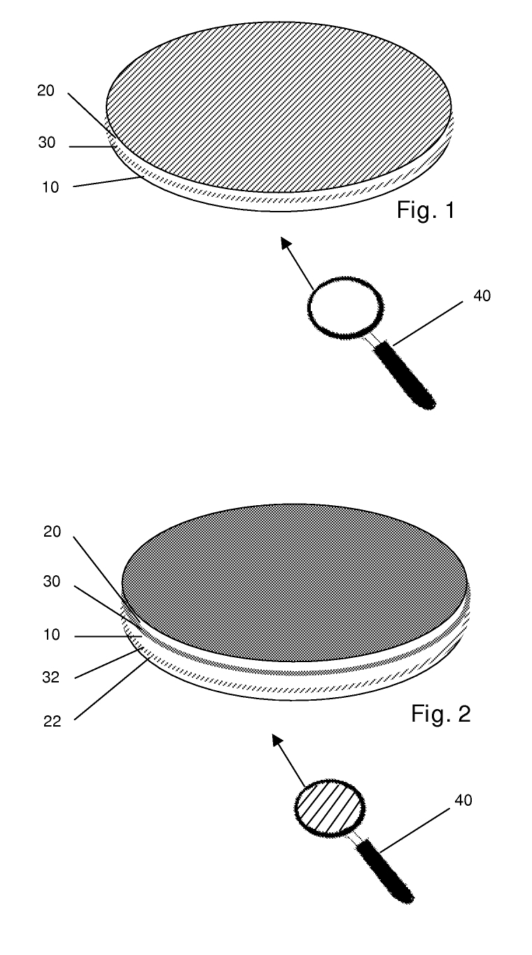

FIG. 1 is a perspective view onto a first embodiment of a sealing insert according to the invention; and

FIG. 2 is a perspective view onto a second embodiment of a sealing insert according to the invention.

Primarily, a sealing insert firstly consists of a support layer 10. In preferred embodiments, this support layer 10 can be a layer of foamed material, e.g. of polyethylene or polypropylene. The support layer 10 is cylindrical, as is the entire sealing insert or also sealing disc; it thus has a circular periphery and largely has the same thickness at every point. Neither of these two is an essential requirement, polygonal sealing discs or those of other shapes are also possible and certain tolerances are also possible in the case of the thickness dimensions.

As may be seen in FIG. 1, the support layer 10 is covered on one side by a first lamination film 20. This lamination film 20 is made of a transparent material, e.g. a film material that is not or only slightly permeable to oxygen. This film is very thin in comparison to the support layer 10 and is optically barely perceptible. The representation in FIG. 1 is not true to scale.

The connection between the lamination film 20 and the support layer 10 is provided by a first adhesive layer 30. This adhesive layer 30 is preferably supplied from the extruder in hot state, and can in particular be a polyolefin. Alternatively, the adhesive layer 30 can also be supplied in the form of a film web during production of the sealing insert.

In contrast to the prior art, this adhesive layer 30 is coloured in the invention. For example, it can have a brilliant ruby red dye added without its adhesion properties being impaired in any way. The dye as well as the rest of the adhesive layer 30 do not penetrate through the support layer 20 or through the lamination film 20, and are therefore not noticeable from the outside, apart from the optical impression that they generate.

If an observer now looks at the sealing insert in the direction shown in FIG. 1, then he is looking from above onto a clear and transparent lamination film 20, i.e. looking through this because of its transparency. Therefore, he is looking at the coloured adhesive layer 30. This coloured adhesive layer 30 conceals the white foamed material of the support layer 10, which is thus no longer visible to the observer. If he looks from below at the sealing insert through a means 40 symbolically represented as a magnifying glass or with the naked eye, then he looks directly at the support layer 10, and therefore sees the white foamed material.

If one imagines the represented magnifying glass 40 to be replaced by an optoelectronic detection device with a tool 40, then on the basis of the perceived colour or the light/dark value, the optoelectronic detection device can automatically detect whether it has detected a coloured adhesive layer 30. From this, the optoelectronic detection device can then deduce that there is evidently also a lamination film 20 present in this embodiment, and therefore it knows which side of the sealing insert is directed towards it.

Consequently, the optoelectronic detection device can now indicate to a control device whether and how to proceed further with the sealing insert.

Another possibility is provided in FIG. 2 in a completely different exemplary embodiment.

In the embodiment of FIG. 2, a second lamination film 22 is laminated on the side of the support layer 10 opposite the first lamination film 20 with the first adhesive layer 30. This second lamination film 22 is also made of a transparent material, e.g. a film material that is not or little permeable to oxygen. This film is also very thin in comparison to the support layer 20 and is optically barely perceptible. It can be identical to the first lamination film 20.

The connection between the second lamination film 22 and the support layer 10 is provided by a second adhesive layer 32. This second adhesive layer 32 is preferably supplied from the extruder in hot state, and can in particular be a polyolefin. Alternatively, the second adhesive layer 32 can also be supplied in the form of a film web during production of the sealing insert.

This second adhesive layer 32 can be coloured like the first adhesive layer 30. It can have the same dye added to it, or also a different dye from the first adhesive layer 30. Likewise in this case, like the rest of the second adhesive layer 32, the dye does not penetrate through the support layer 10 on one side or through the second lamination film 22 on the other side. Apart from the optical impression on the observer, there is likewise no difference from the outside.

If, an observer now looks at the sealing insert through a magnifying glass 40 schematically indicated in FIG. 2, then while he looks at the clear and transparent first lamination film 20 (from above) or the second lamination film 22 (from below), he looks through these to the first coloured adhesive layer 30 or the second coloured adhesive layer 32. The adhesive layers 30 and 32 respectively conceal the white foamed material of the support layer 10, which is thus no longer visible to the observer. If one imagines the magnifying glass 40 to be replaced by an optoelectronic detection device with a tool 40, then this can also automatically decide on the basis of the perceived colour which colour it has seen or whether it has seen a colour at all. From this, an optoelectronic detection device can then deduce which side of the sealing insert is directed towards it. This can also be a non-coloured adhesive layer, for example.

Accordingly, the optoelectronic detection device 40 can cause the sealing insert to either be rotated or segregated for further processing or otherwise be further processed or transported in unchanged state.

If the transparent lamination film 20 does not preclude this, a dye material detectable by ultraviolet or infrared light can also be used for coloration of the adhesive layer 30.

The tools 40 for the optoelectronic scanning do not have to be complicated for this application case, since they merely have to distinguish two different states (light, dark) from one another, for no other states can arise. This can be easily achieved by suitable selection of the dye, and accordingly the optoelectronic tool 40 can also very quickly bring the decision made to bear on the devices connected downstream.

### LIST OF REFERENCE NUMERALS

10 support layer
20 first lamination film
22 second lamination film
30 adhesive layer
32 second adhesive layer
40 magnifying glass

1. Sealing insert for container closures, comprising:
a support layer,
a transparent lamination film, and
an adhesive layer connecting the lamination film to the support layer,
wherein the adhesive layer has a different light/dark value and/or a different colour from the support layer.

2. Sealing insert according to claim 1, wherein the adhesive layer is coloured.

3. Sealing insert according to claim 2, wherein the support layer is provided with a second transparent lamination film on the side opposite the first transparent lamination film, and that a second adhesive layer connecting the second lamination film to support layer is also coloured.

4. Sealing insert according to claim 3, wherein the first adhesive layer and the second adhesive layer are coloured in different colours.

5. Sealing insert according to claim 1, wherein the support layer is a foamed material.

6. Sealing insert according to claim 5, wherein the support layer is a polyethylene foam.

7. Sealing insert according to claim 1, wherein the support layer is made of a white material.

8. Sealing insert according to claim 3, wherein the first adhesive layer and, the second adhesive layer are coloured with a colour, which clearly contrasts with the colour of the support layer.

9. Sealing insert according to claim 3, wherein the adhesive layers are extruded as a hot adhesive medium and are inserted between the support layer and the lamination film.

10. Sealing insert according to claim 9, wherein the adhesive layers are formed by an extruded polyolefin with an added dye.

11. Sealing insert according to claim 3, wherein the coloured adhesive layers are each an adhesive film sheet.

12. Multilayered film web for the production of sealing inserts comprising:
a support layer,
a transparent lamination film and
an adhesive layer connecting the lamination film to the support layer,
wherein the adhesive layer has a different light/dark value and/or a different colour from the support layer.

13. A multilayered film web according to claim 12 wherein the support layer is provided with a second transparent lamination film on the side opposite the first transparent lamination film, and that a second adhesive layer connecting the second lamination film to support layer is also coloured.

14. A multilayered film web according to claim 13 wherein wherein the first adhesive layer and the second adhesive layer are coloured in different colours.

15. Sealing insert according to claim 12, wherein the support layer is a foamed material.

16. Sealing insert according to claim 15, wherein the support layer is a polyethylene foam.

17. Sealing insert according to claim 12, wherein the support layer is made of a white material.

18. Sealing insert according to claim 13, wherein the first adhesive layer and the second adhesive layer are coloured with a colour, which clearly contrasts with the colour of the support layer.

19. Sealing insert according to claim 13, wherein the adhesive layers are extruded as a hot adhesive medium and are inserted between the support layer and the lamination film.

20. Sealing insert according to claim 19, wherein the adhesive layers are formed by an extruded polyolefin with an added dye.

21. Sealing insert according to claim 13, wherein the coloured adhesive layers are each an adhesive film sheet.
